(19) United States
(12) Patent Application Publication
(10) Pub. No.: US 2022/0400650 A1
(43) Pub. Date: Dec. 22, 2022

(54) BOWL FOR PETS

(71) Applicant: Jason Hagenow, Madison, WI (US)

(72) Inventor: Jason Hagenow, Madison, WI (US)

(21) Appl. No.: 17/842,496

(22) Filed: Jun. 16, 2022

Related U.S. Application Data
(60) Provisional application No. 63/212,406, filed on Jun. 18, 2021.

(51) Int. Cl. A01K 5/01; A01K 7/00

(52) U.S. Cl. CPC A01K 5/01; A01K 7/00

(57) ABSTRACT

A bowl is disclosed that has an outer bowl body having an outer bowl wall that extends between a bottom edge and an upper edge, where the bottom edge supports the bowl on a receiving surface. The bowl further includes a trench having a base trench wall with an outer trench wall and an inner trench wall extending upwardly therefrom. The outer trench wall is coupled to the upper edge of the outer bowl wall. The bowl includes an inner bowl body having a base inner bowl wall with a peripheral wall extending upwardly therefrom. The peripheral wall is coupled to an upper edge of the inner trench wall. The bowl includes a drainage passageway that extends through the inner trench wall of the trench and the peripheral wall of the inner bowl body. The drainage passageway places the trench in fluid communication with the inner bowl body.

### CROSS-REFERENCE TO RELATED APPLICATIONS

This application claims priority to U.S. Provisional Patent Application No. 63/212,406, filed on Jun. 18, 2021, which is herein incorporated by reference in full.

### STATEMENT REGARDING FEDERALLY SPONSORED RESEARCH

Not applicable.

### BACKGROUND

A bowl may be used to store a volume of liquid or a mass of food. Dog or animal bowls can be filled with drinkable liquids, and various types of pet food to include hard or soft food, wet or dry, as well as various types of food normally fit for human consumption.

### SUMMARY OF THE DISCLOSURE

To address the aforementioned issues, an improved bowl is disclosed herein that reduces water and food spillage in areas around the bowl. Further the improved bowl provided herein has a reduced propensity for becoming tipped or knocked over.

In some aspects, the present disclosure provides a bowl that can include an outer bowl body having an outer bowl wall that extends between a bottom edge and an upper edge, where the bottom edge supports the bowl on a receiving surface (e.g., a floor or table). The bowl can further include a trench having a base trench wall with an outer trench wall and an inner trench wall extending upwardly therefrom. The outer trench wall can be coupled to the upper edge of the outer bowl wall. The bowl can include an inner bowl body having a base inner bowl wall with a peripheral wall extending upwardly therefrom. The peripheral wall can be coupled to an upper edge of the inner trench wall. The bowl can include a drainage passageway that extends between (e.g., through) the inner trench wall of the trench and the peripheral wall of the inner bowl body. The drainage passageway places the trench in fluid communication with the inner bowl body.

In some aspects, the present disclosure provides a bowl that can include an inner bowl defining an inner bowl volume. Additionally, the bowl can include a trench surrounding a periphery of the inner bowl body and defining a trench volume. At least one drainage passageway can extend between the inner bowl body and the trench so that the inner bowl volume is in fluid communication with the trench volume.

In some aspects the present disclosure provides a bowl that can include an outer bowl wall, an inner bowl body, a trench, and a plurality of drainage passageways. The outer bowl can define an outer periphery of the bowl and can include a foot extending from a bottom edge of the outer bowl wall to support the bowl on a receiving surface. The inner bowl body can be positioned to the interior of the outer bowl wall and can have a base inner bowl wall and a peripheral wall extending upward from the base inner bowl wall. Together, the base inner bowl wall and the peripheral wall define an inner bowl volume. The trench can be positioned between the inner bowl body and the outer bowl wall. The trench can have a base trench wall, an inner trench wall coupled to the base inner bowl wall to at an inner lip, and an outer trench wall coupled to the outer bowl wall to at an outer lip. Together, the base trench wall, the inner trench wall, and the outer trench wall define a trench volume. The plurality of drainage passageways can extend between the inner trench wall and the peripheral wall so that the inner bowl volume is in fluid communication with the trench volume. Each of the plurality of drainage passageways can be configured as a U-shaped channel. Further, the base trench wall can be configured to cause a fluid within the trench volume to flow to the plurality of drainage passages and into the inner bowl volume.

These and other advantages and features of the present invention will become more apparent from the following detailed description of the preferred aspects of the present invention when viewed in conjunction with the accompanying drawings.

### DESCRIPTION OF THE DRAWINGS

FIG. 1 is a perspective view of a bowl in accordance with one or more aspects of the present disclosure.

FIG. 2 is a front view of the bowl in FIG. 1, according to one or more aspects of the present disclosure.

FIG. 3 is a top view of the bowl in FIG. 1, according to one or more aspects of the present disclosure.

FIG. 4 is a bottom view of the bowl in FIG. 1, according to one or more aspects of the present disclosure.

FIG. 5 is a perspective, cross-sectional view of the bowl in FIG. 1, according to one or more aspects of the present disclosure.

### DETAILED DESCRIPTION

Before the present disclosure is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements.

Dog bowls come in many shapes and sizes, and have been designed to provide several functions, including bowls that automatically dispense liquid within the bowl, bowls that aerate water, bowls that slow down the rate at which the animal drinks, and bowls that prevent large amounts of water from spilling if the dog overturns the bowl. While these dog bowls solve some common problems associated with their use, one issue not fully addressed is the problem of drooling.

As most dog owners are aware, as the dog drinks from a bowl, not all the water comes in contact with or makes it into the dog's mouth and is digested. Instead, depending on the size of the dog, large amounts of water spill over the area near the bowl. Moreover, as the dog moves away from the watering spot, any drool accumulated follows the dog, leaving a trail of water all over the floor. Dog owners consistently need to clean up the water trail as a result of the drool.

Further, many dog bowl designs have a hemispherical design where the exterior side walls project outward from a flat base at an obtuse angle between the base and the side wall. Exterior walls that project outward create natural tipping points for the bowl, allowing a dog to easily tip and spill the contents of the bowl.

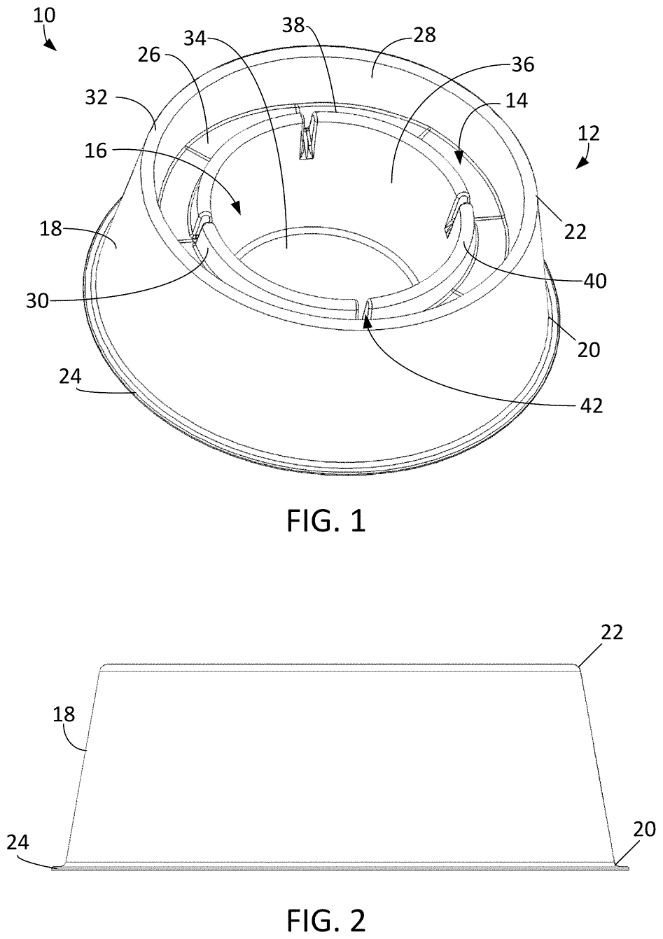

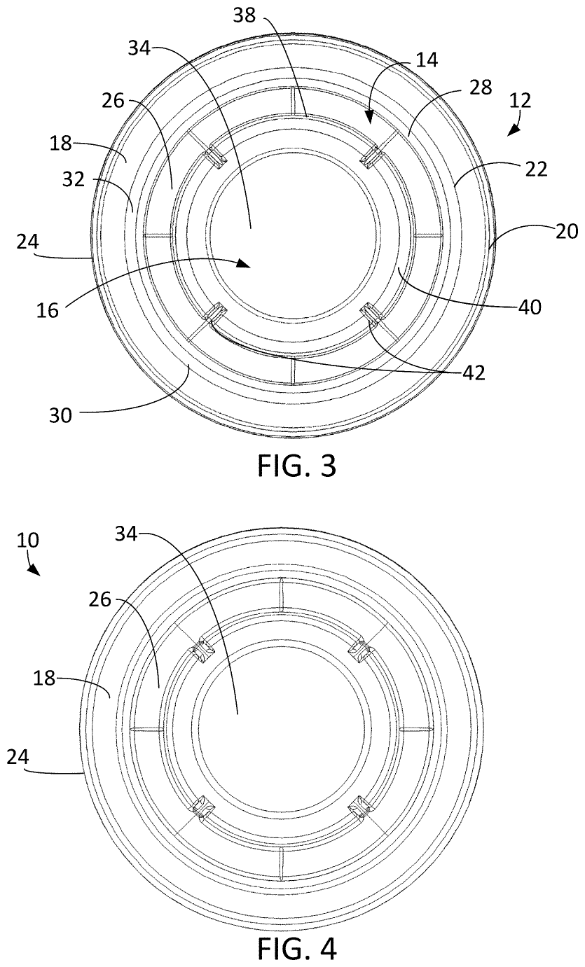

Referring to FIGS. 1-5, a bowl 10 is illustrated according to some aspects of the present disclosure. The bowl 10 is configured to store a volume of liquid, a mass of food, or a combination thereof. In some embodiments, the bowl 10 has three main parts including an outer bowl body 12, a trench 14, and an inner bowl body 16. The outer bowl body 12 includes an outer bowl wall 18 that extends between a bottom edge 20 and an upper edge 22. The bottom edge 20 is configured to support the bowl 10 on a receiving surface (e.g., the ground, table, counter, etc.). In some embodiments, the bottom edge 20 further includes a foot support 24 that extends from the bottom edge 20. The foot support 24 may be configured to extend from the bottom edge 20 such that it is substantially parallel or parallel with the receiving surface. As used herein, the term “substantially parallel” refers to a gradient percentage of plus or minus 3%, 2%, 1.5%, 1%, 0.5%, 0.1%, or values therebetween relative to the receiving surface.

As mentioned above, one of the problems associated with traditional dog bowl geometries is that the outer walls are angled outward relative to the receiving surface so that they extend away from the internal volume of the traditional bowl. This design creates natural tipping points for the bowl, allowing the dog to easily tip and spill the contents of the bowl. For example, the dog may paw the outer wall, causing the bowl to tip. Unlike the traditional design, the provided bowl 10 may have an outer bowl wall 18 that is angled inward relative to the receiving surface toward the inner bowl body 16. The inward angle of the outer bowl wall 18 and the optional foot support 24 reduces the likelihood that a dog may tip the bowl 10 over. In some embodiments, the bottom of the foot support 24 may include a polymeric or rubber material to increase the adhesion between the receiving surface and the foot support 24. This may further reduce the likelihood of tipping or knocking over the bowl 10.

In some embodiments, the angle between the outer bowl wall 18 and a horizontal axis defined by the bottom edge 20 ranges from 30 degrees to 90 degrees. In some embodiments, the angle at least 30 degrees, or at least 35 degrees, or at least 40 degrees, or at least 45 degrees, or at least 50 degrees, or at least 55 degrees, or at least 60 degrees, to less than 65 degrees, or less than 70 degrees, or less than 75 degrees, or less than 80 degrees, or less than 85 degrees, or less than 90 degrees.

Referring back to FIG. 1, the bowl 10 includes a trench 14 extending around a periphery (e.g., an entire or partial periphery) of the inner bowl body 16. The trench 14 has a base trench wall 26. The base trench wall 26 includes an outer trench wall 28 and an inner trench wall 30 extending upwardly therefrom. The base trench wall 26, the outer trench wall 28, and the inner trench wall 30 define a trench volume therein. The outer trench wall 28 extends from the base trench wall 26 to the upper edge 22 of the outer bowl wall 18. The outer trench wall 28 and the outer bowl wall 18 may be directly coupled at the upper edge 22, or may be coupled through a lip 32 (e.g., an outer lip). The bowl 10 further includes an inner bowl body 16 having a base inner bowl wall 34. A peripheral wall 36 extends upwardly from the base inner bowl wall 34 and is coupled to an upper edge 38 of the inner trench wall 30. The peripheral wall 36 may be directly coupled at the upper edge 38, or may be coupled through a lip 40 (e.g., an inner lip). The inner bowl wall 34 and the peripheral wall 36 define an inner bowl volume. In some embodiments, the outer lip 32 can be higher than the inner lip 40 so that a distance between the receiving surface and the outer lip 32 is greater than a distance between the receiving surface and the inner lip 32. Accordingly, the outer lip 32 can define a highest point of the bowl 10.

In some embodiments, the bowl 10 includes at least one drainage passageway 42 that extends through the inner trench wall 30 and the peripheral wall 36 to place the trench volume in fluid communication with the inner bowl volume. As discussed above, as a dog drinks from a bowl, not all the water comes in contact with or makes it into the mouth of the dog. Drool often spills over the sides of a traditional bowl design and accumulates in areas around the traditional bowl. The trench 14 of bowl 10 provides a catch mechanism for accumulating drool and water that does not make it into the mouth of the dog, and reduces the amount of water spilled outside of the bowl 10. The at least one drainage passageway 42 returns the liquid back to the inner bowl volume.

In some embodiments, the bowl 10 includes a plurality of drainage passageways 42 configured around the circumference of the inner bowl body 16. For example, the bowl 10 may include at least one drainage passageway 42, at least two, at least three, at least four, at least five, at least 10, at least 20, to less than 30, or less than 40, less than 50, less than 100 drainage passageways 42. In some embodiments, the drainage passageways 42 are arranged such that each drainage passageway 42 positioned on the inner bowl body 16 includes a drainage passageway 42 positioned on an opposing side of the inner bowl body 16. Further, where multiple drainage passageways 42 are provided, the drainage passageways can be equally or unequally spaced (e.g., circumferentially spaced) around the inner bowl body 16.

In some embodiments, the at least one drainage passageway 42 forms an open channel. As used herein, the term “open channel” refers to a drainage passageway 42 that includes at least one side exposed to a surrounding gas (e.g., air). For example, the open channel may have any geometry, but typically has a U-shaped or V-shaped cross-section. Although not depicted in FIG. 1, the at least one drainage passageway 42 may form a closed channel. As used herein, the term “closed channel” refers to a drainage passageway 42 that has an internal volume enclosed by side walls. In the case of a closed channel, the inner lip 40 may be extended to enclose the internal volume of the drainage passageway 42 to form a closed channel.

In some embodiments, the base trench wall 26 is disposed vertically above the base inner bowl wall 34 (e.g., so that the base trench wall 26 is closer to the lip inner 40 than is the base inner bowl wall 34) and is sloped (e.g., radially inward) to direct the fluid in the trench 14 toward the inner bowl body 16. In some embodiments, the base trench wall 14 has a grade percentage of at least 0.1%. As used herein, the term “grade percentage” is taken as the as the slope of the base trench wall 14 expressed as a percentage, e.g.,

$$100 \times \frac{rise}{run}$$

of the base trench wall 14, relative to a radial reference frame defined by a central vertical axis of the bowl 10. In some embodiments, the grade percentage is at least 0.1%, or at least 1%, or at least 2%, or at least 3%, or at least 4%, or at least 5%, or at least 6%, or at least 7%, to less than 8%, less than 9%, less than 10%, less than 15%, less than 20%, or less than 30%, or less than 40%, or less than 45%. In some cases, configuring the base trench wall 26 with sufficient grade percentage can help to cause a fluid to flow more efficiently toward the drainage passageways 42 so that any fluid caught the trench 14 flows more efficiently through the drainage passageways 42 and into the inner bowl body 16.

The bowl 10 may be made from various materials. In some embodiments, the bowl 10 is composed of a polymer, a ceramic, a metal, or combinations thereof. In some embodiments, the bowl 10 is molded (e.g., injection molded) from a single material. Suitable polymers include, but are not limited to, polyethylene, polypropylene, polycarbonate, or a combination thereof. Suitable ceramics include, but are not limited to, earthenware, stoneware, porcelain, barium titanate, bismuth strontium calcium copper oxide, boron oxide, boron nitride, ferrite, lead zirconate titanate, magnesium diboride, silicon aluminum oxynitride, silicon carbide, silicone nitride, magnesium silicates, titanium carbide, uranium oxide, zinc oxide, zirconium dioxide, or combinations thereof. Suitable metals include, but are not limited to, stainless steel, aluminum, titanium, a combination or alloy thereof.

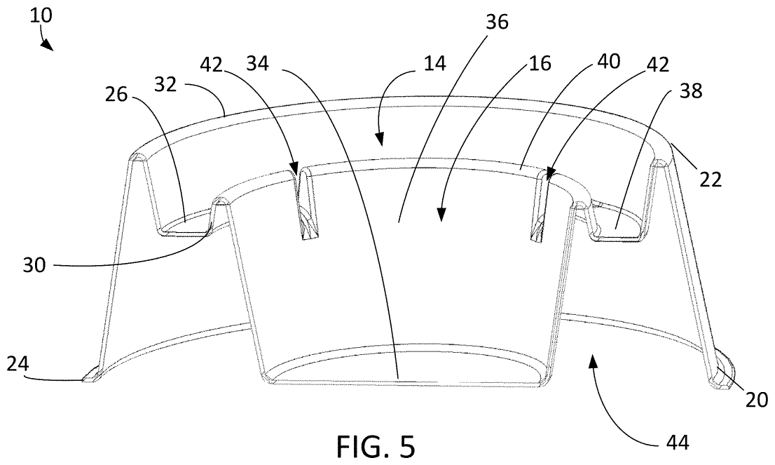

Referring to FIG. 5, in some embodiments, the bowl 10 further includes an internal cavity 44 formed between the outer bowl wall 18 and the peripheral wall 36 of the inner bowl body 16. The internal cavity 44 may be insulative, e.g., filled with air. The internal cavity 44 offers benefits over traditional bowl designs. For example, if a hot liquid or food is disposed in the internal bowl body 16, the internal cavity 44 may be insulate the outer bowl wall 18 and prevent the outer bowl wall 18 from heating to the temperature of the peripheral wall 36. In this way, a user may hold onto the outer bowl wall 18 comfortably, even if the contents present in the internal bowl body 16 are at an elevated temperature. For example, if the bowl 10 is used as a reservoir for human food that is warm (e.g., hot soup) or heated in a microwave, the outer bowl wall 18 will remain at a cooler temperature relative to the internal bowl body 16.

Still referring to FIG. 5, in some embodiments, a height (i.e., as measured perpendicular to a receiving surface that supports the bowl 10) of the inner trench wall 30 above the base trench wall 26 is smaller than a height of the outer trench wall 28 above the base trench wall 26. For example, the height of outer trench wall 28 may be at least 1.1 times larger than the inner trench wall 30, or at least 1.5 times larger, or at least 2 times larger, or at least 2.5 times larger, or at least 3 times larger than the height of the inner trench wall 30. In some embodiments, a bottom side of the base inner bowl wall 34 may be configured to engage and/or rest on the receiving surface that supports the bowl 10. In some embodiments, a bottom side of the base inner bowl wall 34 may be spaced from the receiving surface for the bowl 10.

Accordingly, a bowl 10 is disclosed that is resistant to tipping over, reduces spilled liquid contents through trench 14 that provides a catch mechanism that returns spilled liquid to inner bowl body 16, and a bowl 10 that has insulative properties that reduces the temperature of the outer bowl wall 18 relative to the internal bowl body 16.

It should be appreciated that various other modifications and variations to the preferred embodiments can be made within the spirit and scope of the invention. Therefore, the invention should not be limited to the described embodiments. To ascertain the full scope of the invention, the following claims should be referenced.

I claim:

1. A bowl comprising:
an outer bowl body having an outer bowl wall that extends between a bottom edge and an upper edge, wherein the bottom edge is configured to support the bowl on a receiving surface;
a trench having a base trench wall with an outer trench wall and an inner trench wall extending upwardly therefrom, wherein the outer trench wall is coupled to the upper edge of the outer bowl wall, the trench defining a trench volume therein;
an inner bowl body having a base inner bowl wall with a peripheral wall extending upwardly therefrom, wherein the peripheral wall is coupled to an upper edge of the inner trench wall, the inner bowl body defining an inner bowl volume; and
at least one drainage passageway that extends between the inner trench wall of the trench and the peripheral wall of the inner bowl body, the drainage passageway placing the trench volume in fluid communication with the inner bowl volume.

2. The bowl of claim 1 further comprising at least two drainage passageways positioned on opposing sides of the inner bowl body.

3. The bowl of claim 1 further comprising at least four drainage passageways positioned on the inner bowl body.

4. The bowl of claim 1 further comprising a base foot connected to the bottom edge of the outer bowl wall, wherein the base foot extends substantially parallel to the receiving surface.

5. The bowl of claim 1, wherein the outer bowl wall is angled inward relative to the receiving surface toward the inner bowl body.

6. The bowl of claim 1, wherein the at least one drainage passageway forms an open channel.

7. The bowl of claim 1, wherein the base trench wall is sloped to direct fluid in the trench toward the inner bowl body.

8. The bowl of claim 7, wherein the base trench wall has a grade percentage of at least 0.1%.

9. The bowl of claim 1 further comprising an internal cavity formed between the outer bowl wall and the peripheral wall of the inner bowl body.

10. The bowl of claim 1, wherein a height of the inner trench wall is smaller than a height of the outer trench wall.

11. The bowl of claim 10, wherein the height of the outer trench wall is at least 1.1 times larger than the height of the inner trench wall.

12. A bowl comprising:
an inner bowl body defining an inner bowl volume;
a trench surrounding a periphery of the inner bowl body and defining a trench volume; and
at least one drainage passageway extending between the inner bowl body and the trench so that the inner bowl volume is in fluid communication with the trench volume via the at least one drainage passageway.

13. The bowl of claim 12, wherein the trench is configured to cause a fluid disposed within the trench volume to flow toward and through the at least one drainage passageway into the inner bowl volume.

14. The bowl of claim 12, wherein a lip is defined between the inner bowl body and the trench and the at least one drainage passageway extends through the lip.

15. The bowl of claim 14, wherein the inner bowl body defines a base inner bowl wall and the trench defines a base trench wall, and
wherein a distance between the base inner bowl wall and the lip is greater than a distance between the base trench wall and the lip.

16. The bowl of claim 14, wherein the at least one drainage passageway is configured as a U-shaped channel.

17. The bowl of claim 12, wherein the at least one drainage passageway is one of a plurality of drainage passageways.

18. A bowl comprising:
an outer bowl wall defining an outer periphery of the bowl, the outer bowl wall including a foot extending from a bottom edge of the outer bowl wall to support the bowl on a receiving surface;
an inner bowl body positioned to the interior of the outer bowl wall, the inner bowl body having a base inner bowl wall and a peripheral wall extending upward from the base inner bowl wall that to together define an inner bowl volume;
a trench positioned between the inner bowl body and the outer bowl wall, the trench having a base trench wall, an inner trench wall coupled to the base inner bowl wall to at an inner lip, and an outer trench wall coupled to the outer bowl wall to at an outer lip, wherein the base trench wall, the inner trench wall, and the outer trench wall define a trench volume; and
a plurality of drainage passageways extending between the inner trench wall and the peripheral wall so that the inner bowl volume is in fluid communication with the trench volume, each of the plurality of drainage passageways being configured as a U-shaped channel;
the base trench wall being configured to cause a fluid within the trench volume to flow to the plurality of drainage passages and into the inner bowl volume.

19. The bowl of claim 18, wherein the plurality of drainage passages is equally spaced around the peripheral wall.

20. The bowl of claim 18, wherein a distance between the base inner bowl wall and the lip is greater than a distance between the base trench wall and the lip, and
wherein the base trench wall is sloped to direct fluid in the trench toward the inner bowl body.
